(19) United States
(12) Patent Application Publication
(10) Pub. No.: US 2013/0268900 A1
(43) Pub. Date: Oct. 10, 2013

(54) TOUCH SENSOR GESTURE RECOGNITION FOR OPERATION OF MOBILE DEVICES

(71) Applicants: Bran Ferren, Beverly Hills, CA (US); David Beal, Pasadena, CA (US); W. Daniel Hillis, Encino, CA (US); Dimitri Negroponte, Los Angeles, CA (US); James Sarrett, Sunland, CA (US)

(72) Inventors: Bran Ferren, Beverly Hills, CA (US); David Beal, Pasadena, CA (US); W. Daniel Hillis, Encino, CA (US); Dimitri Negroponte, Los Angeles, CA (US); James Sarrett, Sunland, CA (US)

(21) Appl. No.: 13/992,699

(22) PCT Filed: Dec. 22, 2010
(86) PCT No.: PCT/US10/61802

§ 371 Date: Jun. 7, 2013

(51) Int. Cl. G06F 3/0488

(52) U.S. Cl. CPC G06F 3/0488
USPC 715/863

(57) ABSTRACT

Touch sensor gesture recognition for operation of mobile devices. An embodiment of a mobile device includes a touch sensor for the detection of gestures, the touch sensor including multiple sensor elements, and a processor, the processor to interpret the gestures detected by the touch sensor, where the mobile device divides the plurality of sensor elements into multiple zones, and the mobile device interprets the gestures based at least in part on which of the zones detects the gesture. An embodiment of a mobile device includes a touch sensor for the detection of gestures, the touch sensor including multiple sensor elements, and a processor, the processor to interpret the gestures detected by the touch sensor, where the processor is to identify one or more dominant actions for an active application or a function of the active application and is to choose a gesture identification algorithm from a plurality of gesture recognition algorithms based at least in part on identified one or more dominant actions, and is to determine a first intended action of a user based on an interpretation of a first gesture using the chosen gesture identification algorithm. An embodiment of a mobile device includes a touch sensor for the detection of gestures, the touch sensor including multiple sensor elements, and a processor, the processor to interpret the gestures detected by the touch sensor, and a mapping between touch sensor data and actual positions of user gestures, the mapping of data being generated by an artificial neural network, where the processor utilizes the mapping at least in part to interpret the gestures.

### TECHNICAL FIELD

Embodiments of the invention generally relate to the field of electronic devices and, more particularly, to a method and apparatus for touch sensor gesture recognition for operation of mobile devices.

### BACKGROUND

Mobile devices, including cellular phones, smart phones, mobile Internet devices (MIDs), handheld computers, personal digital assistants (PDAs), and other similar devices, provide a wide variety of applications for various purposes, including business and personal use.

A mobile device requires one or more input mechanisms to allow a user to input instructions and responses for such applications. As mobile devices become smaller yet more full-featured, a reduced number of user input devices (such as switches, buttons, trackballs, dials, touch sensors, and touch screens) are used to perform an increasing number of application functions.

However, conventional input devices are limited in their ability to accurately reflect the variety of inputs that are possible with complex mobile devices. Conventional device inputs may respond inaccurately or inflexibly to inputs of users, thereby reducing the usefulness and user friendliness of mobile devices.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of an embodiment of a mobile device;

FIG. 2 is an illustration of embodiments of touch sensors that may be included in a mobile device;

FIG. 3 is an illustration of an embodiment of a process for pre-processing of sensor data;

FIG. 4 is an illustration of embodiments of touch sensors with multiple zones in a mobile device;

FIGS. 5A and 5B are flowcharts to illustrate embodiments of a process for dividing and utilizing a touch sensor with multiple zones;

FIG. 6 is a diagram to illustrate an embodiment including selection of gesture identification algorithms;

FIG. 7 is a flowchart to illustrate an embodiment of a process for gesture recognition;

FIG. 8 is an illustration of an embodiment of a system for mapping sensor data with actual gesture movement;

FIG. 9 is a flow chart to illustrate an embodiment of a process for generating map data for gesture identification;

FIG. 10 is a flow chart to illustrate an embodiment of a process for utilizing map data by a mobile device in identifying gestures; and

FIG. 11 illustrates an embodiment of a mobile device.

### DETAILED DESCRIPTION

Embodiments of the invention are generally directed to touch sensor gesture recognition for operation of mobile devices.

As used herein:

“Mobile device” means a mobile electronic device or system including a cellular phone, smart phone, mobile Internet device (MID), handheld computers, personal digital assistants (PDAs), and other similar devices.

“Touch sensor” means a sensor that is configured to provide input signals that are generated by the physical touch of a user, including a sensor that detects contact by a thumb or other finger of a user of a device or system.

In some embodiments, a mobile device includes a touch sensor for the input of signals. In some embodiments, the touch sensor includes a plurality of sensor elements. In some embodiments, a method, apparatus, or system provides for:

(1) A zoned touch sensor for multiple, simultaneous user interface modes.

(2) Selection of a gesture identification algorithm based on an application.

(3) Neural network optical calibration of a touch sensor.

In some embodiments, a mobile device includes an instrumented surface designed for manipulation via a finger of a mobile user. In some embodiments, the mobile device includes a sensor on a side of a device that may especially be accessible by a thumb (or other finger) of a mobile device user. In some embodiments, the surface of a sensor may be designed in any shape. In some embodiments, the sensor is constructed as an oblong intersection of a saddle shape. In some embodiments, the touch sensor is relatively small in comparison with the thumb used to engage the touch sensor.

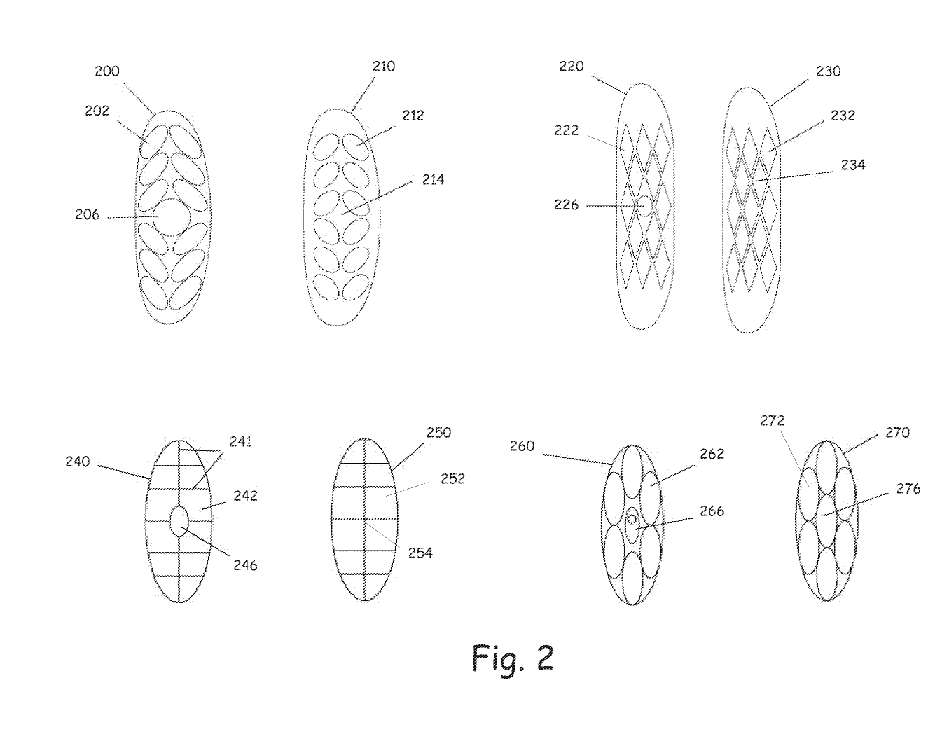

In some embodiments, instrumentation for a sensor is accomplished via the use of capacitance sensors and/or optical or other types of sensors embedded beneath the surface of the device input element. In some embodiments, these sensors are arranged in one of a number of possible patterns in order to increase overall sensitivity and signal accuracy, but may also be arranged to increase sensitivity to different operations or features (including, for example, motion at an edge of the sensor area, small motions, or particular gestures). Many different sensor arrangements for a capacitive sensor are possible, including, but not limited to, the sensor arrangements illustrated in FIG. 2 below.

In some embodiments, sensors include a controlling integrated circuit that is interfaced with the sensor and designed to connect to a computer processor, such as a general-purpose processor, via a bus, such as a standard interface bus. In some embodiments, sub-processors are variously connected to a computer processor responsible for collecting sensor input data, where the computer processor may be a primary CPU or a secondary microcontroller, depending on the application. In some embodiments, sensor data may pass through multiple sub-processors before the data reaches the processor that is responsible for handling all sensor input.

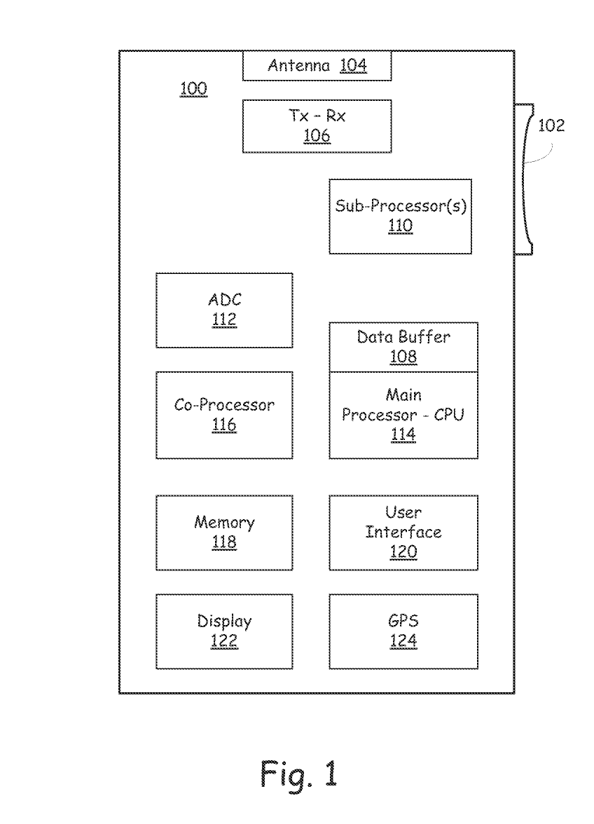

FIG. 1 is an illustration of an embodiment of a mobile device. In some embodiments, the mobile device 100 includes a touch sensor 102 for input of commands by a user using certain gestures. In some embodiments, the touch sensor 102 may include a plurality of sensor elements. In some embodiments, the plurality of sensor elements includes a plurality of capacitive sensor pads. In some embodiments, the touch sensor 102 may also include other sensors, such as an optical sensor. See, U.S. patent application Ser. No. 12/650,582, filed Dec. 31, 2009 (Optical Capacitive Thumb Control With Pressure Sensor); U.S. patent application Ser. No. 12/646,220, filed Dec. 23, 2009 (Contoured Thumb Touch Sensor Apparatus). In some embodiments, raw data is acquired by the mobile device 100 from one or more sub-processors 110 and the raw data is collected into a data buffer 108 of a processor, such as main processor (CPU) 114 such that all sensor data can be correlated with each sensor in order to process the signals. The device may also include, for example, a coprocessor 116 for computational processing. In some embodiments, an example multi-sensor system utilizes an analog to digital converter (ADC) element or circuit 112, wherein the ADC 112 may be designed for capacitive sensing in conjunction with an optical sensor designed for optical flow detection, wherein both are connected to the main processor via different busses. In some embodiments, the ADC 112 is connected via an I2C bus and an optical sensor is connected via a USB bus. In some embodiments, alternative systems may include solely the ADC circuit and its associated capacitive sensors, or solely the optical sensor system.

In some embodiments, in a system in which data is handled by a primary CPU 114, the sensor data may be acquired by a system or kernel process that handles data input before handing the raw data to another system or kernel process that handles the data interpretation and fusion. In a microcontroller or sub-processor based system, this can either be a dedicated process or timeshared with other functions.

The mobile device may further include, for example, one or more transmitters and receivers 106 for the wireless transmission and reception of data, as well as one or more antennas 104 for such data transmission and reception; a memory 118 for the storage of data; a user interface 120, including a graphical user interface (GUI), for communications between the mobile device 100 and a user of the device; a display circuit or controller 122 for providing a visual display to a user of the mobile device 100; and a location circuit or element, including a global positioning system (GPS) circuit or element 124.

In some embodiments, raw data is time tagged as it enters into the device or system with sufficient precision so that the raw data can both be correlated with data from another sensor, and so that any jitter in the sensor circuit or acquisition system can be accounted for in the processing algorithm. Each set of raw data may also have a pre-processing algorithm that accounts for characteristic noise or sensor layout features which need to be accounted for prior to the general algorithm.

In some embodiments, a processing algorithm then processes the data from each sensor set individually and (if more than one sensor type is present) fuses the data in order to generate contact, position information, and relative motion. In some embodiments, relative motion output may be processed through a ballistics/acceleration curve to give the user fine control of motion when the user is moving the pointer slowly. In some embodiments, a separate processing algorithm uses the calculated contact and position information along with the raw data in order to recognize gestures. In some embodiments, gestures that the device or system may recognize include, but are not limited to: finger taps of various duration, swipes in various directions, and circles (clockwise or counter-clockwise). In some embodiments, a device or system includes one or more switches built into a sensor element or module together with the motion sensor, where the sensed position of the switches may be directly used as clicks in control operation of the mobile device or system.

In some embodiments, the output of processing algorithms and any auxiliary data is available for usage within a mobile device or system for operation of user interface logic. In some embodiments, the data may be handled through any standard interface protocol, where example protocols are UDP (User Datagram Protocol) socket, Unix™ socket, D-Bus (Desktop Bus), and UNIX/dev/input device.

FIG. 2 is an illustration of embodiments of touch sensors that may be included in a mobile device. In some embodiments, a touch sensor may include any pattern of sensor elements, such as capacitive sensors, that are utilized in the detection of gestures. In some embodiments, the touch sensor may include one or more other sensors to assist in the detection of gestures, including, for example, an optical sensor.

In this illustration, a first touch sensor 200 may include a plurality of oval capacitive sensors 202 (twelve in sensor 200) in a particular pattern, together with a centrally placed optical sensor 206. A second sensor 210 may include similar oval capacitive sensors 212 with no optical sensor in the center region 214 of the sensor 210.

In this illustration, a third touch sensor 220 may include a plurality of diamond-shaped capacitive sensors 222 in a particular pattern, together with a centrally placed optical sensor 226. A fourth sensor 230 may include similar diamond-shaped capacitive sensors 232 with no optical sensor in the center region 234 of the sensor 230.

In this illustration, a fifth touch sensor 240 may include a plurality of capacitive sensors 242 separated by horizontal and vertical boundaries 241, together with a centrally placed optical sensor 246. A sixth sensor 250 may include similar capacitive sensors 252 as the fifth sensor with no optical sensor in the center region 254 of the sensor 250.

In this illustration, a seventh touch sensor 260 may include a plurality of vertically aligned oval capacitive sensors 262, together with a centrally placed optical sensor 266. An eighth sensor 270 may include similar oval capacitive sensors 272 with no optical sensor in the center region 276 of the sensor 270.

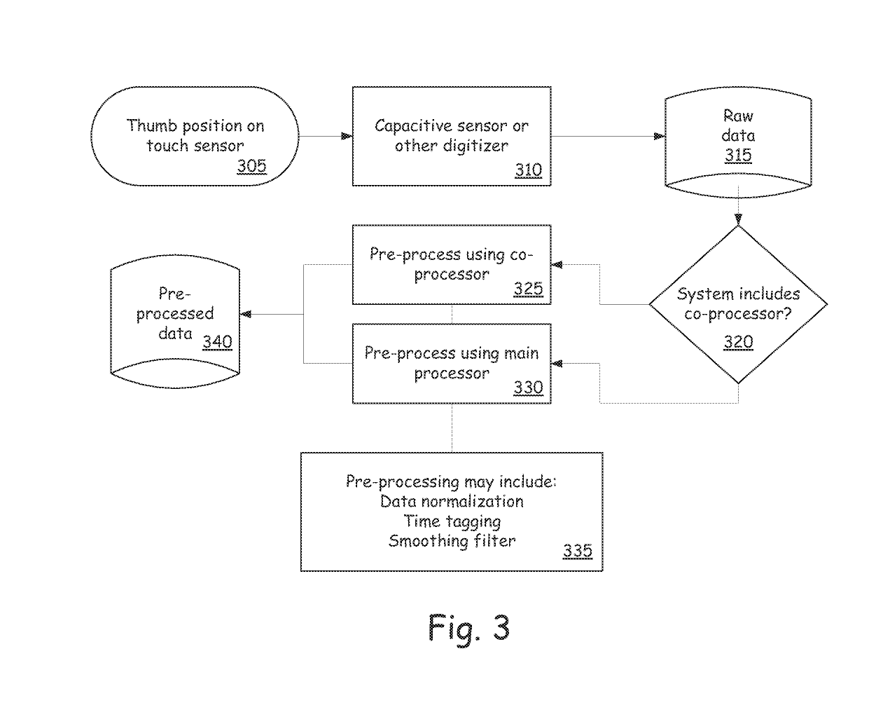

FIG. 3 is an illustration of an embodiment of a process for pre-processing of sensor data. In this illustration, the position of a thumb (or other finger) on a sensor 305 results in signals generated by one or more capacitive sensors or other digitizers 310, such signals resulting in a set of raw data 315 for preprocessing. If a system or device includes a co-processor 320, then preprocessing may be accomplished utilizing the co-processor 325. Otherwise, the preprocessing may be accomplished utilizing the main processor of the system or device 330. In either case, the result is a set of preprocessed data for processing in the system or device 340. The preprocessing of the raw data may include a number of functions to transform data into more easily handled formats 335, including, but not limited to, data normalization, time tagging to correlate data measurements with event times, and imposition of a smoothing filter to smooth abrupt changes in values. While preprocessing of raw data as illustrated in FIG. 3 is not provided in the other figures, such preprocessing may apply in the processes and apparatuses provided in the other figures and in the descriptions of such processes and apparatuses.

Zoned Touch Sensor for Multiple, Simultaneous User Interface Modes

In some embodiments, a device or system divides the touch sensing area of a touch sensor on a mobile device into multiple discrete zones and assigns distinct functions to inputs received in each of the zones. In some embodiments, the number, location, extent and assigned functionality of the zones may be configured by the application designer or reconfigured by the user as desired. In some embodiments, the division of the touch sensor into discrete zones allows the single touch sensor to emulate the functionality of multiple separate input devices. In some embodiments, the division may be provided for a particular application or portion of an application, while other applications may be subject to no division of the touch sensor or to a different division of the touch sensor.

In one exemplary embodiment, a touch sensor is divided into a top zone, a middle zone, and bottom zone, and the inputs in each zone are assigned to control different functional aspects of, for example, a dual-camera zoom system. In this example, inputs (such as taps by a finger of a user on the touch sensor) within the top zone toggle the system between automatic and manual focus; inputs within the middle zone (such as taps on the touch sensor) operate the camera, initiating image capture; and inputs within the bottom zone operate the zoom function. For example, an upward movement in the bottom zone could zoom inward and a downward movement in the bottom zone could zoom outward. In other embodiments, a touch sensor may be divided into any number of zones for different functions of an application.

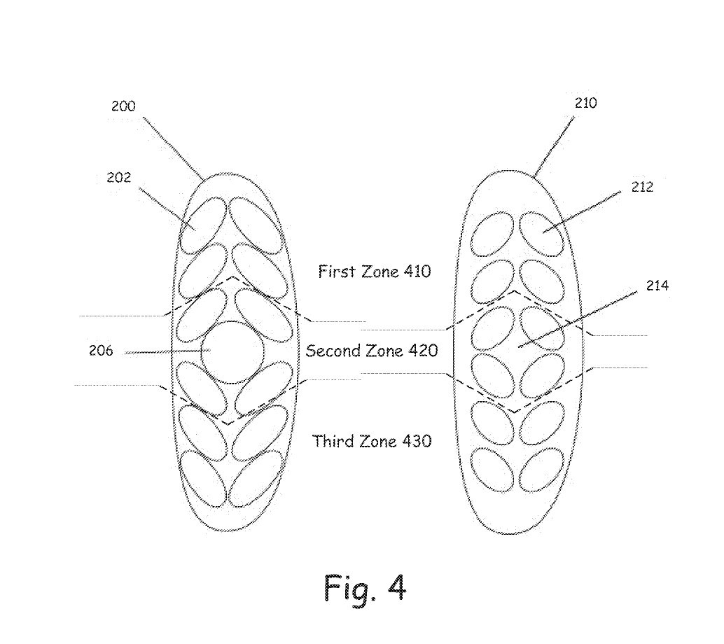

FIG. 4 is an illustration of embodiments of touch sensors with multiple zones in a mobile device. In this illustration, a touch sensor, such as, for example, touch sensor 200 including multiple capacitive sensors 202 and optical sensor 206 or touch sensor 210 including multiple capacitive sensors 212 having a center region 214 that does not include an optical sensor, is divided into multiple zones. In this particular example, the touch sensor 200, 210 are divided into three zones, the zones being a first zone 410 being the upper portion of the touch sensor, a second zone 420 being the middle portion of the touch sensor, and a third zone 430 being the lower portion of the touch sensor. In some embodiments, gestures, such as taps or motions, may be interpreted as having different meanings in each of the three zones, such as, for example, the meanings assigned for a camera function described above.

In some embodiments, continuous, moving contacts with the touch sensor (for example, gestures such as swipes along the touch sensor) that cross from one zone to another, such as crossing between zone 1 410 and zone 2 420, or between zone 2 420 and zone 3 430, may be handled in one of several ways. In a first approach, a mobile device may operate such that any gesture commencing in one region and finishing in another is ignored. In a second approach, a mobile device may be operated such that any gesture commencing in one region and finishing in another region is divided into two separate gestures, one in each zone, with each of the two gestures interpreted as appropriate for each zone. In addition, the existence of a “neutral” region (a dead space in the touch sensor) between adjacent zones in a touch sensor of a mobile device may be utilized to reduce the likelihood that a user will unintentionally commence a gesture in one region and finish the gesture in another.

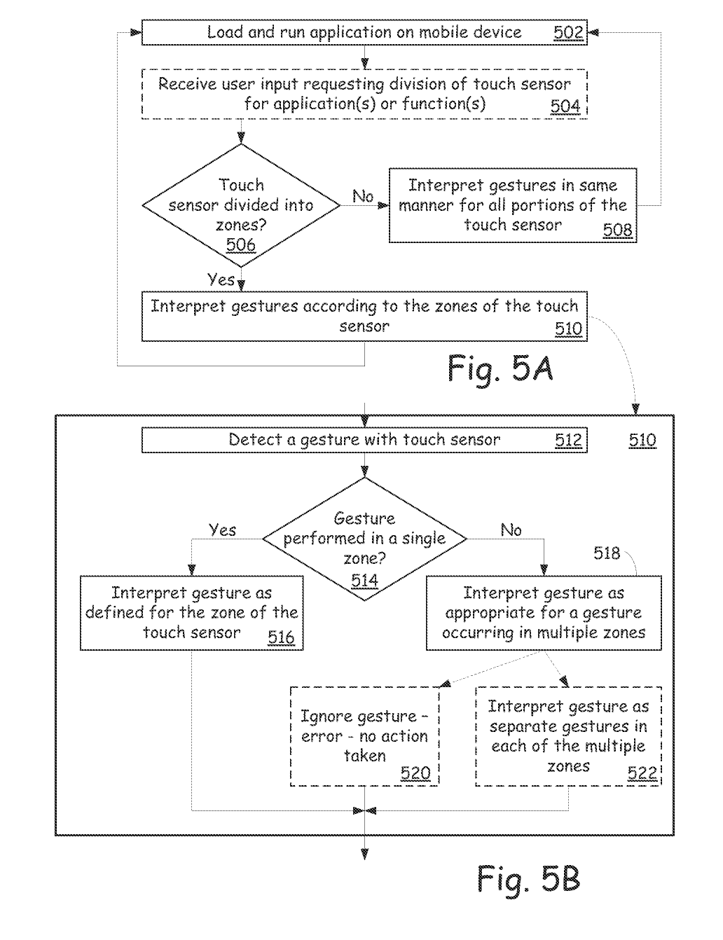

FIGS. 5A and 5B are flowcharts to illustrate embodiments of a process for dividing and utilizing a touch sensor with multiple zones. As illustrated in FIG. 5A, in some embodiments, an application or a portion of an application is provided on a mobile device 502. In some embodiments, an application may be designed to provide for division of a touch sensor, and in some embodiments the division of a touch sensor may result from commands received from a user of the mobile device or other command source. In this illustration, the mobile device receives user input requesting division of the touch sensor for one or more applications or functions 504. In some embodiments, the mobile device may allow for dynamic modification of the division of the touch sensor as needed by the user.

If the touch sensor of a mobile device has not been divided into zones 506, then the mobile device may operate to interpret gestures in the same manner for all portions of the touch sensor 508. If the touch sensor is divided into zones 506, then the mobile device may interpret detected gestures according to the zone within which the gesture is detected 510.

FIG. 5B illustrates embodiments of processes for a mobile device interpreting detected gestures according to the zone within which the gesture is detected 510. Upon the detection of a gesture with a zoned touch sensor 512, if the detected gesture is performed solely within a single zone of the touch sensor 514, then the gesture is interpreted as defined for the zone of the touch sensor within which the gesture occurs 516. If the detected gesture is not performed within a single zone of the touch sensor 514, such as when a finger swipe crosses multiple zones of the touch sensor, then the gesture may be interpreted in a matter that is appropriate for a gesture occurring in multiple zones 518. In one example, the gesture may be ignored on the assumption that the user performed the gesture in error, with no action being taken 520. In another example, the gesture may be interpreted as separate gestures within each of the multiple zones 522. For example, a finger swipe from point A in zone 1 to point B in zone 2 may be interpreted as a first swipe in zone 1 from point A to the crossing point along the boundary between zone 1 and zone 2, and a second swipe in zone 2 from the crossing point along the boundary between zone 1 and zone 2 to point B.

Selection of Gesture Identification Algorithm Based on Application

In some embodiments, a mobile device provides for selecting a gesture recognition algorithm with characteristics that are suited for a particular application.

Mobile devices having user interfaces incorporating a touch sensor may have numerous techniques available for processing the contact, location, and movement information detected by the touch sensor to identify gestures corresponding to actions to be taken within the controlled application. Selection of a single technique for gesture recognition requires analysis of tradeoffs because each technique may have certain strengths and weaknesses, and certain techniques thus may be better at identifying some gestures than others. Correspondingly, the applications running on a mobile device may vary in their need for robust, precise, and accurate identification of particular gestures. For example, a particular application may require extremely accurate identification of a panning gesture, but be highly tolerant of a missed tapping gesture.

In some embodiments, a system operating on a mobile device selects a gesture recognition algorithm from among a set of available gesture recognition algorithms for a particular application. In some embodiments, the mobile device makes such selection on a real-time basis in the operation of the mobile device.

In some embodiments, a system on a mobile device selects a gesture algorithm based on the nature of the current application. In some embodiments, the system on a mobile device operates on the premise that each application operating on the mobile device (for example, a contact list, a picture viewer, a desktop, or other application) may be characterized by one or more “dominant” actions (where the dominant actions may be, for example, the most statistically frequent actions, or the most consequential actions), where each such dominant action is invoked by a particular gesture. In some embodiments, a system on a mobile device selects a particular gesture algorithm in order to identify the corresponding gestures robustly, precisely, and accurately.

In an example, for a contact list application, the dominant actions may be scrolling and selection, where such actions may be invoked by swiping and tapping gestures on the touch sensor of a mobile device. In some embodiments, when the contact list application is the active application for a mobile device, the system or mobile device invokes a gesture identification algorithm that can effectively identify both swiping and tapping gestures. In this example, the chosen gesture identification algorithm may be less effective at identifying other gestures, such as corner-to-corner box selection and “lasso” selection, that are not dominant gestures for the application. In some embodiments, if a picture viewer is the active application, a system or mobile device invokes a gesture identification algorithm that can effectively identify two-point separation and two-point rotation gestures corresponding to zooming and rotating actions, where such gestures are dominant gestures of the picture viewer application.

In some embodiments, a system or mobile device may select a gesture identification algorithm based on one or more specific single actions anticipated within a particular application. In an example, upon loading a contact lists application, a system or mobile device may first invoke a gesture algorithm that most effectively identifies swiping gestures corresponding to a scrolling action, on the assumption that a user will first scroll the list to find a contact of interest. Further in this example, after scrolling has, for example, ceased for a certain period of time, the system or mobile device may invoke a gesture identification algorithm that most effectively identifies tapping gestures corresponding to a selection action, on the assumption that once the user has scrolled this list to a desired location, the user will select a particular contact of interest.

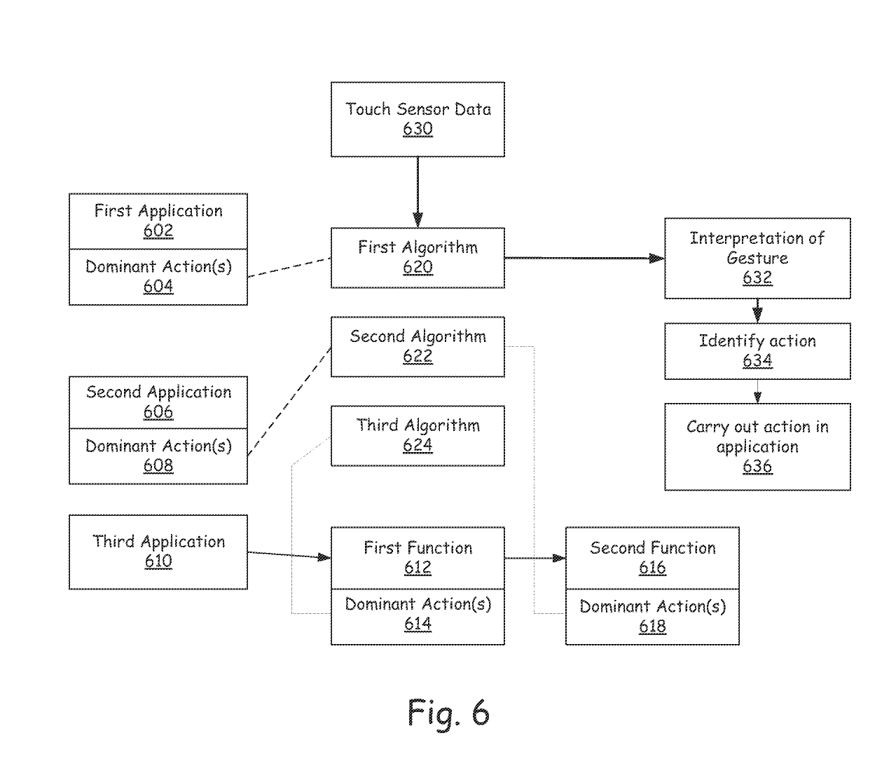

FIG. 6 is a diagram to illustrate an embodiment including selection of gesture identification algorithms. In some embodiments, a mobile device may have a plurality of gesture identification algorithms available, including, for example, a first algorithm 620, a second algorithm 622, and a third algorithm 624. Applications that operate on the mobile device may have one or more dominant actions for the application or for certain functions of the application. In some embodiments, the mobile device selects a gesture identification algorithm for each application or function. In some embodiments, the mobile device chooses the gesture identification algorithm based at least in part on which of the algorithms provides better functionality in identifying the gestures for the one or more dominant actions of the application or function.

In this illustration, a first application 602 has one or more dominant actions 604, where such dominant actions are better handled by the first algorithm 620. Further, a second application 606 has one or more dominant actions 608, where such dominant actions are better handled by the second algorithm 622. A third application 610 may include multiple functions or subparts, where the dominant actions of the functions or subparts may differ. For example, a first function 612 has one or more dominant actions 614, where such dominant actions are better handled by the third algorithm 624 and a second function 616 has one or more dominant actions 618, where such dominant actions are better handled by the second algorithm 622.

As illustrated by FIG. 6, a certain set of touch sensor data 630 may be collected in connection with a gesture made in the operation of the first application 602. The touch sensor data 630 may include pre-processed data 340, as illustrated in FIG. 3. In some embodiments, the mobile device utilizes the first algorithm 620 for the identification of gestures because such algorithm is the better algorithm for identification of gestures corresponding to the dominant actions 604 for the first application 602. In some embodiments, the use of the algorithm with the collected data results in an interpretation of the gesture 632 and determination of the corresponding action 634 for the application. In some embodiments, the mobile device then carries out the action 636 in the context of the first application 602.

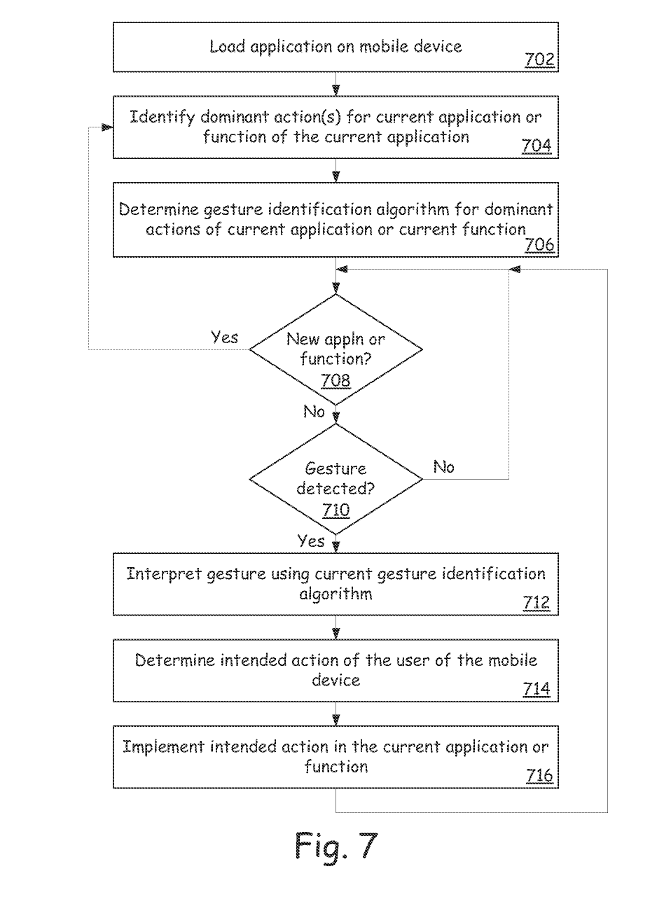

FIG. 7 is a flowchart to illustrate an embodiment of a process for gesture recognition. In some embodiments, an application is loaded on a mobile device 702 and the one or more dominant actions for the current application or for the current function of the application are identified 704. In some embodiments, the mobile device determines a gesture identification algorithm based at least in part on the dominant actions of the current application or function 706. In some embodiments, if there is a change in the current active application or function 708, then the mobile device may again identify the one or more dominant actions for the current application or for the current function of the application 704 and determine a gesture identification algorithm based at least in part on the dominant actions 706.

In some embodiments, if gesture is detected 710, then the mobile device operates to identify the gesture using the currently chosen gesture identification algorithm 712 and thereby determine the intended action of the user of the mobile device 714. The mobile device may then implement the intended action in the context of the current application or function 716.

Neural Network Optical Calibration of Capacitive Thumb Sensor

In some embodiments, a system or mobile device provides for calibration of a touch sensor, where the calibration includes a neural network optical calibration of the touch sensor.

Many capacitive touch sensing surfaces operate based on “centroid” algorithms, which take a weighted average of a quantity derived from the instantaneous capacitance reported by each capacitive sensor pad multiplied by that capacitive sensor pad's position in space. In such algorithms, the resulting quantity for a touch sensor operated with a user's thumb (or other finger) is a capacitive “barycenter” for the thumb, which may either be treated as the absolute position of the thumb or differentiated to provide relative motion information as would a mouse.

For a sensor operated by a user's thumb (or other finger), however, the biomechanics of the thumb may lead to an apparent mismatch between the user's expectation of pointer motion and the measured barycenter for such motion. In particular, as the thumb is extended through its full motion in a gesture of a capacitive touch sensor, the tip of the thumb generally lifts away from the surface of the capacitive sensors. In a centroid-based capacitive sensor algorithm, this yields an apparent (proximal) shift in the calculated position of the thumb while the user generally expects that the calculated position will continue to track the distal extension of the thumb. Thus, instead of tracking the user's perceived position of the finger tip, the centroid algorithm will “roll-back” along the proximodistal axis (the axis running from the tip of the thumb to the basal joint joining the thumb to the hand).

Additionally, the small size of the touch sensor relative to the thumb presents additional challenges. In a thumb sensor consisting of a physically small array of capacitive elements, many of the elements are similarly affected by the thumb at any given thumb position.

Collectively, these two phenomena make it exceedingly challenging to construct a mapping from capacitive sensor readings to calculated thumb positions that matches the user's expectations. In practice, traditional approaches, including hand-formulated functions with adjustable parameters and use of a non-linear optimizer (for example, the Levenberg-Marquardt algorithm) are generally unsuccessful.

In some embodiments, a system or apparatus provides an effective technique for generating a mapping between capacitive touch sensor measurements and calculated thumb positions.

In some embodiments, a system or apparatus uses an optical calibration instrument to determine actual thumb (or other finger) positions. In some embodiments, the actual thumb positions and the contemporaneous capacitive sensor data are provided to an artificial neural network (ANN) during a training procedure. An ANN in general is a mathematical or computational model to simulate the structure and/or functional aspects of biological neural networks, such as a system of programs and data structures that approximates the operation of the human brain. In some embodiments, a resulting ANN provides a mapping between the capacitive sensor data from the touch sensor and the actual thumb positions (which may be two-dimensional (2D, which may be expressed as a position in x-y coordinates) or three-dimensional (3D, which may be expressed as x-y-z coordinates), depending on the interface requirements of the device software) in performing gestures. In some embodiments, a mobile device may use the resulting mapping between capacitive sensor data and actual thumb positions during subsequent operation of the capacitive thumb sensor.

In some embodiments, an optical calibration instrument may be a 3D calibration rig or system, such as a system similar to those commonly used by computer vision scientists to obtain precise measurements of physical objects. The uncertainties in the measurements provided by such a rig or system are presumably small, with the ANN training procedure being resilient to any remaining noise in the training data. However, embodiments are not limited to any particular optical calibration system.

In some embodiments, the inputs to the ANN may be raw capacitive touch sensor data. In some embodiments, the inputs to the ANN may alternatively include historical sensor data quantities derived from past measurements of the capacitive touch sensors. In some embodiments, the training procedure for the ANN implements a nonparametric regression, that is, the training procedure for the ANN does not merely determine parameters within a predetermined functional form but determines the functional form itself.

In some embodiments, an ANN may be utilized to provide improved performance in comparison with manually generated mappings for “pointing” operations, such as cursor control. An ANN is generally adept at interpreting touch sensor measurements that would be difficult or impossible for a programmer to anticipate and handle within handwritten code. An ANN-based approach can successfully develop mappings for a wide variety of arrangements of capacitive sensor pads on a sensor surface. In particular, ANNs may operate to readily accept measurements from larger electrodes (as compared to the size of the thumb) arrayed in an irregular shape (such as a non-grid arrangement), thereby extracting improved (over handwritten code) position estimates from potentially ambiguous capacitive measurements. In some embodiments, the ANN training procedure and operation may also be extended to other sensor configurations, including sensor fusion approaches, such as hybrid capacitive and optical sensors.

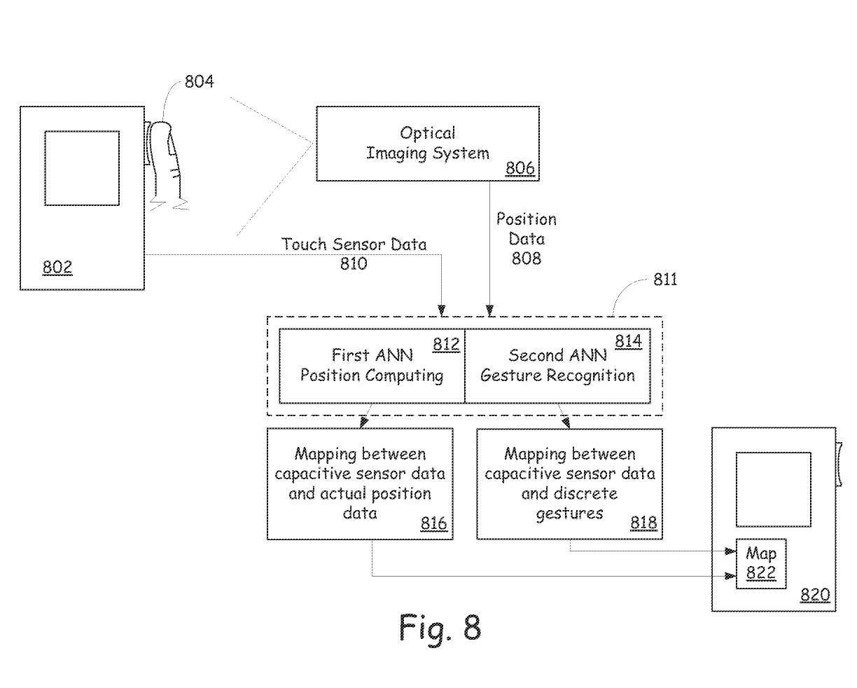

FIG. 8 is an illustration of an embodiment of a system for developing a mapping between touch sensor data and actual thumb (or other finger) positions. In some embodiments, a sequence of predetermined calibration gestures (providing a range of thumb positions attained during typical device operation) are performed by a user's thumb 804 on the touch sensor of a mobile device 802, and the position of the thumb through time is measured by a system such as an optical imaging system 806. The optical imaging system 806 may include a 3D system that measures positions in 3D space. In some embodiments, the position data 808 generated by the optical imaging system 806 and capacitive sensor data 810 generated by the touch sensor of the mobile device 802 (which may include preprocessed data 340 as provided in FIG. 3) are provided to one or more artificial neural networks 811 for analysis. In some embodiments, the one or more neural networks 811 include a first neural network 812 to generate a mapping between the sensor data and actual position data 816. In some embodiments, the one or more neural networks include a second neural network 814 to generate a mapping between the sensor data and certain discrete gestures 818. In some embodiments, a single neural network may provide both of these neural network operations. In some embodiments, the sensor data generated by the mobile device 802 may include sensor data from other sensors, such an optical sensor included in the touch sensor. In some embodiments, the sensor data from other sensors may also be provided to the one or more artificial neural networks 811. In some embodiments, the mapping 816, 818 is provided as mapping data 822 in some form to a mobile device 820, such as during the construction or programming of the mobile device 820. In some embodiments, the mobile device 820 utilizes the mapping data 822 in interpreting gestures in order to determine the actual gestures intended by users of the mobile device.

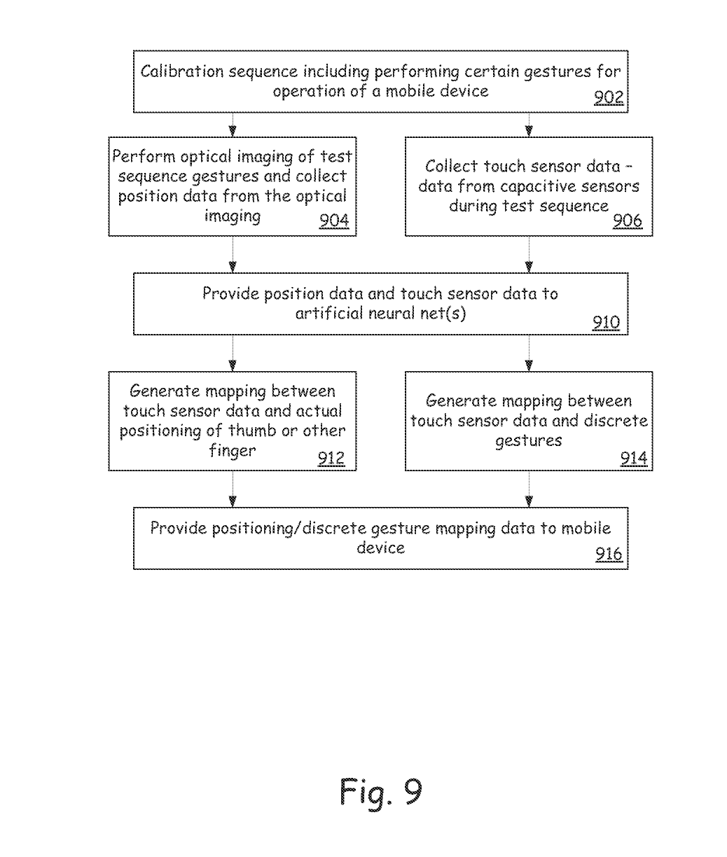

FIG. 9 is a flow chart to illustrate an embodiment of a process for generating a mapping between touch sensor data and actual thumb (or other finger) positions. As noted above, in some embodiments, a calibration sequence may be conducted, including the performance of certain common gestures used for the operation and control of a mobile device 902. In some embodiments, measurements of the position of the thumb through time are made, such as by performance of optical imaging using an optical imaging system, and the position data from the optical imaging is collected 904. In some embodiments, the capacitive sensor data from the touch sensor of the mobile device is also collected 906. In some embodiments, data may be processed as shown in FIG. 3. In some embodiments, such data is provided to one or more artificial neural networks 910. In some embodiments, an artificial neural network (a first artificial neural network) generates a mapping between the touch sensor data and the actual positioning of the thumb in the calibration sequence 912. In some embodiments, an artificial neural network (which may be second artificial neural network or may be the first artificial network) receiving raw data over time may further generate a mapping between the touch sensor data and discrete gestures that are performed 914. In some embodiments, the mapping data, which may include a mapping between sensor data and actual positions, a mapping between sensor data and discrete gestures, or both, is provided to a mobile device 916 for use in a process for interpreting detected gestures.

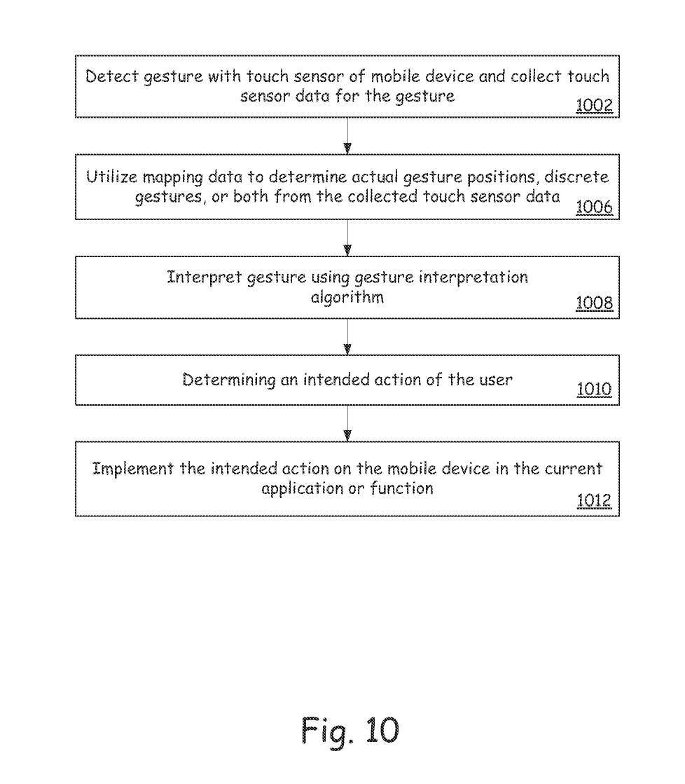

FIG. 10 is a flow chart to illustrate an embodiment of a process for utilizing mapping data by a mobile device in identifying gestures. In some embodiments, the touch sensor of a mobile device detects a gesture with a touch sensor of a mobile device and collects touch sensor data for the gesture 1002. In some embodiments, mapping data between sensor data and actual positioning of a thumb (or other finger), mapping data between sensor data and discrete gestures, or both, generated using one or more artificial neural networks, is used to determine the actual thumb (or finger) position, a discrete gesture, or both 1006. In some embodiments, data may be preprocessed as provided in FIG. 3. In some embodiments, the actual thumb positions are interpreted using a separate gesture identification algorithm 1008 to identify a gesture and determine a corresponding intended action of the user of the mobile device 1010. In some embodiments, the mobile device then implements the intended action on the mobile device in the context of the current application or function 1012.

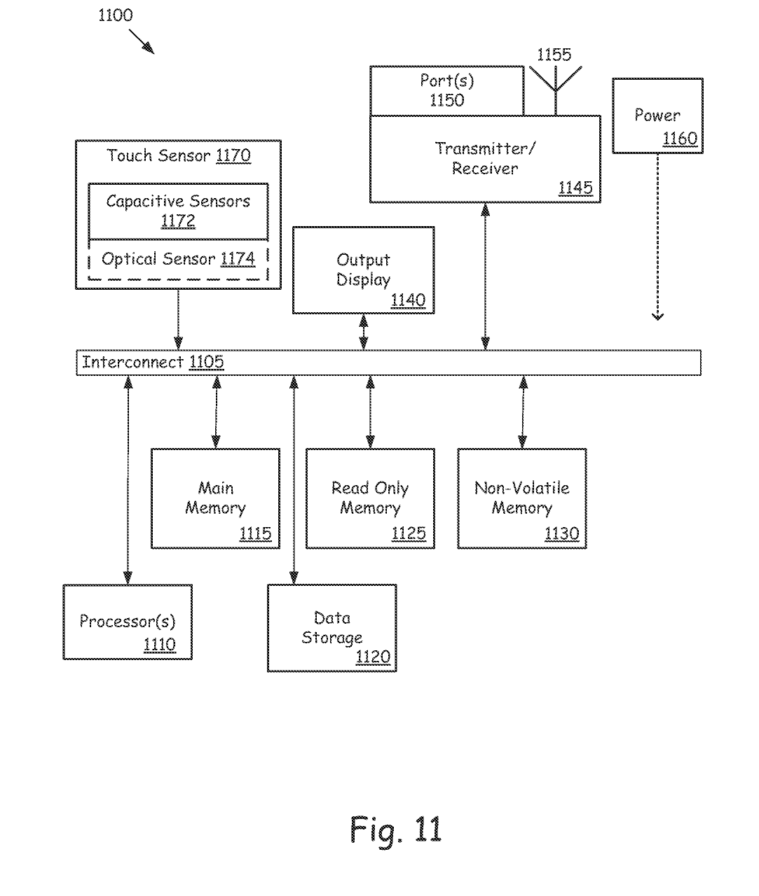

FIG. 11 illustrates an embodiment of a mobile device. In this illustration, certain standard and well-known components that are not germane to the present description are not shown. Under some embodiments, the mobile device 1100 comprises an interconnect or crossbar 1105 or other communication means for transmission of data. The device 1100 may include a processing means such as one or more processors 1110 coupled with the interconnect 1105 for processing information. The processors 1110 may comprise one or more physical processors and one or more logical processors. The interconnect 1105 is illustrated as a single interconnect for simplicity, but may represent multiple different interconnects or buses and the component connections to such interconnects may vary. The interconnect 1105 shown in FIG. 11 is an abstraction that represents any one or more separate physical buses, point-to-point connections, or both connected by appropriate bridges, adapters, or controllers.

In some embodiments, the device 1100 further comprises a random access memory (RAM) or other dynamic storage device or element as a main memory 1115 for storing information and instructions to be executed by the processors 1110. Main memory 1115 also may be used for storing data for data streams or sub-streams. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). In some embodiments, memory of the system may include certain registers or other special purpose memory. The device 1100 also may comprise a read only memory (ROM) 1125 or other static storage device for storing static information and instructions for the processors 1110. The device 1100 may include one or more non-volatile memory elements 1130 for the storage of certain elements.

Data storage 1120 may also be coupled to the interconnect 1105 of the device 1100 for storing information and instructions. The data storage 1120 may include a magnetic disk, an optical disc and its corresponding drive, or other memory device. Such elements may be combined together or may be separate components, and utilize parts of other elements of the device 1100.

The device 1100 may also be coupled via the interconnect 1105 to an output display 1140. In some embodiments, the display 1140 may include a liquid crystal display (LCD) or any other display technology, for displaying information or content to a user. In some environments, the display 1140 may include a touch-screen that is also utilized as at least a part of an input device. In some environments, the display 1140 may be or may include an audio device, such as a speaker for providing audio information.

One or more transmitters or receivers 1145 may also be coupled to the interconnect 1105. In some embodiments, the device 1100 may include one or more ports 1150 for the reception or transmission of data. The device 1100 may further include one or more antennas 1155 for the reception of data via radio signals.

The device 1100 may also comprise a power device or system 1160, which may comprise a power supply, a battery, a solar cell, a fuel cell, or other system or device for providing or generating power. The power provided by the power device or system 1160 may be distributed as required to elements of the device 1100.

In some embodiments, the device 1100 includes a touch sensor 1170. In some embodiments, the touch sensor 1170 includes a plurality of capacitive sensor pads 1172. In some embodiments, the touch sensor 1170 may further include another sensor or sensors, such as an optical sensor 1174.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1-12. (canceled)

13. A mobile device comprising:
a touch sensor for the detection of gestures, the touch sensor including a plurality of sensor elements; and
a processor, the processor to interpret the gestures detected by the touch sensor;
wherein the processor is to identify one or more dominant actions for an active application or a function of the active application and is to choose a gesture identification algorithm from a plurality of gesture recognition algorithms based at least in part on identified one or more dominant actions; and
wherein the processor is to determine a first intended action of a user based on an interpretation of a first gesture using the chosen gesture identification algorithm.

14. The mobile device of claim 13, wherein the processor is to choose a different one of the plurality of gesture identification algorithms for a second application or function.

15. The mobile device of claim 13, wherein the processor is to choose a different one of the plurality of gesture identification algorithms for a second function of the application.

16. The mobile device of claim 13, wherein the plurality of sensor elements includes a plurality of capacitive sensor elements.

17. The mobile device of claim 16, wherein the plurality of sensor elements includes an optical sensor.

18. A method comprising:
loading an application on a mobile device, the mobile device including a touch sensor;
identifying one or more dominant actions for the application or a function of the application;
choosing a gesture identification algorithm of a plurality of gesture identification algorithms for the one or more dominant actions;
detecting a first gesture with the touch sensor;
interpreting the first gesture using the gesture identification algorithm, where interpreting the first gesture includes determining that a first action corresponds to the first gesture; and
implementing the first action in the current application or function.

19. The method of claim 18, wherein the processor is to choose a different one of the plurality of gesture identification algorithms for a second application or function.

20. The method of claim 18, wherein the processor is to identify a different one of the plurality of gesture identification algorithms for a second function of the application.

21. The method of claim 18, wherein detecting the first gesture using the touch sensor includes detecting a gesture made by a thumb or finger of a user on the touch sensor.

22-39. (canceled)
